(19) United States
(12) Patent Application Publication
(10) Pub. No.: US 2016/0007120 A1
(43) Pub. Date: Jan. 7, 2016

(54) ELECTRONIC DEVICE AND A HEATSINK ARRANGEMENT ASSOCIATED THEREWITH

(71) Applicant: Creative Technology Ltd, Singapore (SG)

(72) Inventors: Kok Fah LEE, Singapore (SG); Chiang Seng ERH, Singapore (SG); Kin Wah CHAN, Singapore (SG); Eileen ONG, Singapore (SG)

(73) Assignee: CREATIVE TECHNOLOGY LTD, Singapore (SG)

(21) Appl. No.: 14/324,063

(22) Filed: Jul. 3, 2014

(51) Int. Cl. H04R 9/02; H04R 1/02

(52) U.S. Cl. CPC H04R 9/022; H04R 1/02

(57) ABSTRACT

A device is provided. The device can include a heatsink arrangement for dissipating heat within the device, a heat generating component, a heat conducting channel and a casing. The casing can be shaped and dimensioned to carry the heatsink arrangement and the heat generating component. The casing can include a first face and a second face. The first and second faces can be spaced apart such that sides are defined therebetween. The first face, the second face and the sides can form an enclosure associable with air volume defined by air enclosed within the enclosure. The heat conducting channel can couple the heat generating component and the heatsink arrangement so as to channel heat from the heat generating component to the heatsink arrangement, thereby reducing amount of heat being dissipated directly to the air volume. The heat generating component and the heat conducting channel are within the enclosure.

### FIELD OF INVENTION

The present disclosure generally relates to a device having a heatsink arrangement. The heatsink arrangement can be useful for dissipating heat within the device.

### BACKGROUND

Portable devices are widely used nowadays. An example is portable speaker devices.

Given that portable devices generally need to be carried around with convenience, their physical dimensions need to be compact. Hence poor heat dissipation can become a concern. This will be discussed using portable speaker device(s) as an example hereinafter.

It is appreciable that due to compactness, heat accumulation within a portable speaker device may cause degradation in performance of the portable speaker device. In worst case scenarios, overheating due to heat accumulation may cause a portable speaker device to malfunction. This is especially more evident with high powered portable speaker devices which may have powerful amplifiers/internal batteries which dissipate a great amount of heat within the portable speaker devices.

An example of the aforementioned malfunction is the inability of the internal battery of a portable speaker to properly charge/recharge when overheating occurs.

Furthermore, many portable speaker devices feature plastic type casings which have poor thermal conductivity. This further contributes to a portable speaker device not being able to dissipate heat efficiently.

It is therefore desirable to provide a solution to address at least one of the foregoing problems.

### SUMMARY OF THE INVENTION

In accordance with an aspect of the disclosure, a device is provided. The device can, for example, be a speaker apparatus which can be configured to output audio signals.

The device can have a heatsink arrangement for dissipating heat within the device. The device can include at least one heat generating component and a casing. The device can further include a heat conducting channel. The heat conducting channel can, for example, be a wired heat transfer medium in the form of braided copper wires.

The casing can be shaped and dimensioned to carry the heatsink arrangement and the heat generating component.

Specifically, the casing can include a first face carrying the heatsink arrangement and a second face carrying the heat generating component. The first and second faces can be spaced apart such that sides are defined between the first and second faces. The first face, the second face and the sides defined can form an enclosure.

The enclosure can be associated with air volume which is defined by air enclosed within the enclosure.

The heat conducting channel can couple the heat generating component and the heatsink arrangement so as to channel heat from the heat generating component to the heatsink arrangement, thereby reducing amount of heat being dissipated from the heat generating component directly to the air volume.

The heat generating component and the heat conducting channel can be within the enclosure.

In one embodiment, the heatsink arrangement can include a first side and a second side. The second side can be opposing the first side. The heatsink arrangement can be carried by the first face in a manner such that the first side of the heatsink arrangement faces outside of the enclosure and the second side of the heatsink arrangement faces inside of the enclosure.

In another embodiment, the device can further include at least one speaker driver configurable to output audio signals. The casing can be further shaped and dimensioned to carry the speaker driver. For example, the speaker driver can be carried by the first face of the casing and the heatsink arrangement can be arranged around the speaker driver.

In one example, the heatsink arrangement is formed around the periphery of the speaker driver.

In another example, the heatsink arrangement and the speaker driver can form a single unit.

### BRIEF DESCRIPTION OF THE DRAWINGS

Embodiments of the disclosure are described hereinafter with reference to the following drawings, in which:

FIG. 1a and FIG. 1b show a device which includes a heatsink arrangement which can be partially exposed to view, in accordance with an embodiment of the disclosure; and

FIG. 2a shows a possible arrangement to obscure/hide the partially exposed heatsink arrangement of FIG. 1 from view, in accordance with an embodiment of the disclosure;

FIG. 2b shows a possible arrangement to blend appearance of the partially exposed heatsink arrangement with the general/overall outward appearance of the device of FIG. 1, in accordance with an embodiment of the disclosure; and

FIG. 2c shows a possible arrangement to blend appearance of the partially exposed heatsink arrangement with the general/overall outward appearance of the device of FIG. 1, in accordance with an embodiment of the disclosure.

### DETAILED DESCRIPTION

Representative embodiments of the disclosure, for addressing one or more of the foregoing problems, are described.

Specifically, the present disclosure relates to a device which includes at least one heatsink arrangement. The heatsink arrangement can also be known as/correspond to an apparatus capable of absorbing and dissipating excess heat (e.g., from the device). The device can, for example, be a speaker device/apparatus. In this regard, the device can be configured to output audio signals.

The device can include a casing, at least one heatsink arrangement (as mentioned earlier), at least one heat generating component, at least one heat conducting channel and, optionally, at least one speaker driver. The casing can be shaped and dimensioned to carry the heatsink arrangement, the heat generating component and/or the speaker driver.

The casing can, for example, be in the form of a rectangular cuboid having a first face, a second face and sides formed between the first and second faces. Additionally, the casing can be shaped and dimensioned such that any casing surface (i.e., the first face, second face or any of the sides) when placed on a substantially flat resting surface (e.g., a tabletop) is substantially flush with the resting surface.

In one exemplary orientation, the first face can be the top part of the casing and the second face can be the bottom part of the casing. Generally, the first face, second face and the sides form/define an enclosure. Appreciably, air can be enclosed within the enclosure. In this regard, the enclosure can be associated with air volume which can be defined by air enclosed within the enclosure.

Based on the above exemplary orientation, the heatsink arrangement and, optionally, the speaker driver can be carried by the top part of the casing. The heat generating component can be carried by the bottom part of the casing.

The heat generating component and the heat conducting channel can be within the enclosure. One part/one side of the heatsink arrangement can be facing inside the enclosure and another part/another side of the heatsink arrangement can be facing outside of the enclosure (i.e., exposed to ambient air outside of the enclosure).

The heatsink arrangement can be coupled to the heat generating component by the heat conducting channel. Specifically, the heat conducting channel can have two ends of which one end can be coupled to the heat generating component and the other end can be coupled to the part/side of the heatsink arrangement facing inside the enclosure.

In general, the heatsink arrangement can function to dissipate heat. For example, the heatsink arrangement functions to dissipate heat within the device. Specifically, heat generated by the heat generating component which is within the device (i.e., within the enclosure) can be channeled/transferred to the heatsink arrangement by the heat conducting channel. Heat can then be transferred from the part/side of the heatsink arrangement facing inside the enclosure to the part/side of the heatsink arrangement facing outside of the enclosure and, subsequently, dissipated to ambient air outside of the enclosure.

Therefore it is appreciable that without the heat conducting channel channeling/transferring heat from the heat generating component to the heatsink arrangement, heat generated by the heat generating component would be dissipated directly to the aforementioned air volume (i.e., within the enclosure). This may cause accumulation of heat within the device and consequently cause reliability/performance issues if temperature within the device exceeds optimal operating temperature.

Appreciably, by channeling/transferring heat generated by the heat generating device to the heatsink arrangement via the heat conducting channel, heat being released/dissipated from the heat generating component directly to the aforementioned air volume can be reduced. This serves to reduce the possibility of heat accumulation within the device causing temperature within the device to rise beyond a level which may cause reliability/performance issues.

Furthermore, since the casing can be shaped and dimensioned such that any casing surface (i.e., the first face, second face or any of the sides) when placed on a substantially flat resting surface (e.g., a tabletop) is substantially flush with the resting surface, when the bottom part of the casing carrying the heat generating component (based on the above exemplary orientation) is placed on a flat resting surface having poor thermal conductivity (e.g., a wooden table top), heat dissipation can be an issue (trapped between the bottom part of the casing and the flat resting surface). In this regard, by the above discussed arrangement of channeling/transferring heat generated by the heat generating device to the heatsink arrangement via the heat conducting channel, the aforementioned issue with heat dissipation when the device is placed on a substantially flat resting surface.

It is further contemplated that the device may inadvertently be placed on a resting surface such that casing surface (i.e., top part/first face based on the above exemplary orientation) carrying the heatsink arrangement may be flush with the resting surface, thus causing a heat dissipation issue. In this regard, by carrying the speaker driver and the heatsink arrangement on the same casing surface (i.e., top part/first face based on the above exemplary orientation), the risk of the device being placed such that the heatsink arrangement is flush with the resting surface is greatly reduced. Specifically, it is contemplated that it is not likely a user would rest the casing surface carrying the speaker driver flush with a resting surface since doing so may muffle audio signals output from the speaker driver.

Further appreciably, since one part/side of the heatsink arrangement faces outside of the enclosure, the heatsink arrangement can partially be exposed to view.

Therefore it is preferable that the visible part/side of the heatsink arrangement does not detract the aesthetic value (i.e., outward appearance) of the device. To achieve this, it is possible to arrange the heatsink arrangement so that it (i.e., part/side of the heatsink arrangement exposed to view) blends with the general/overall outward appearance of the device.

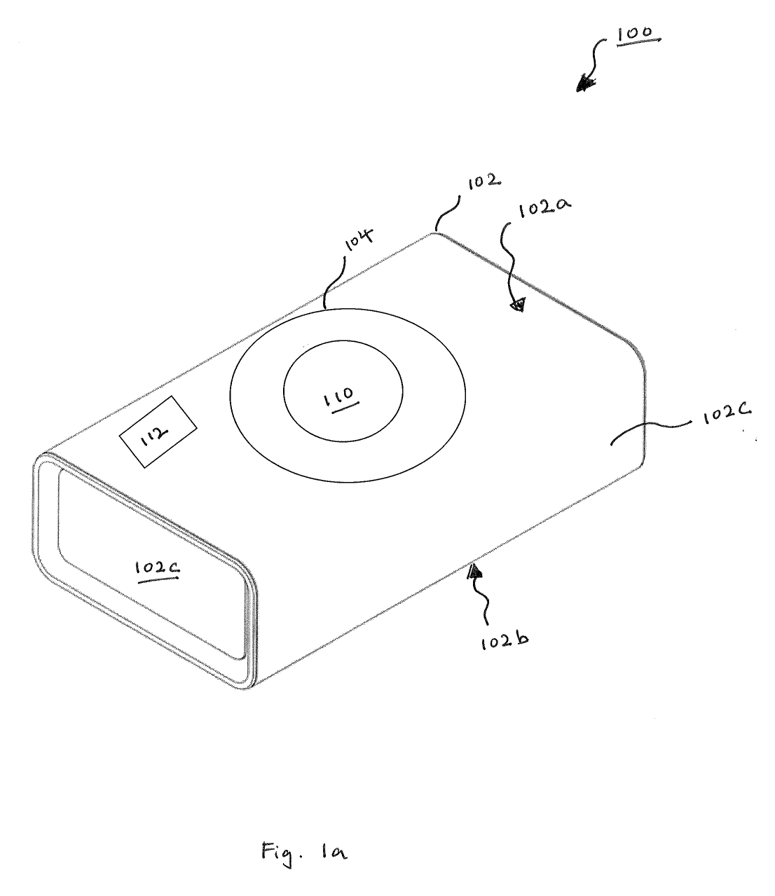

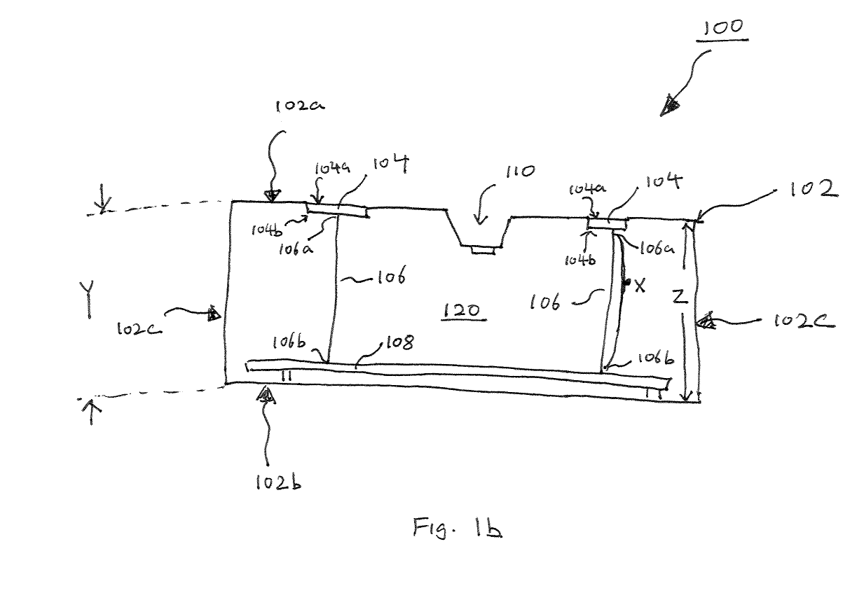

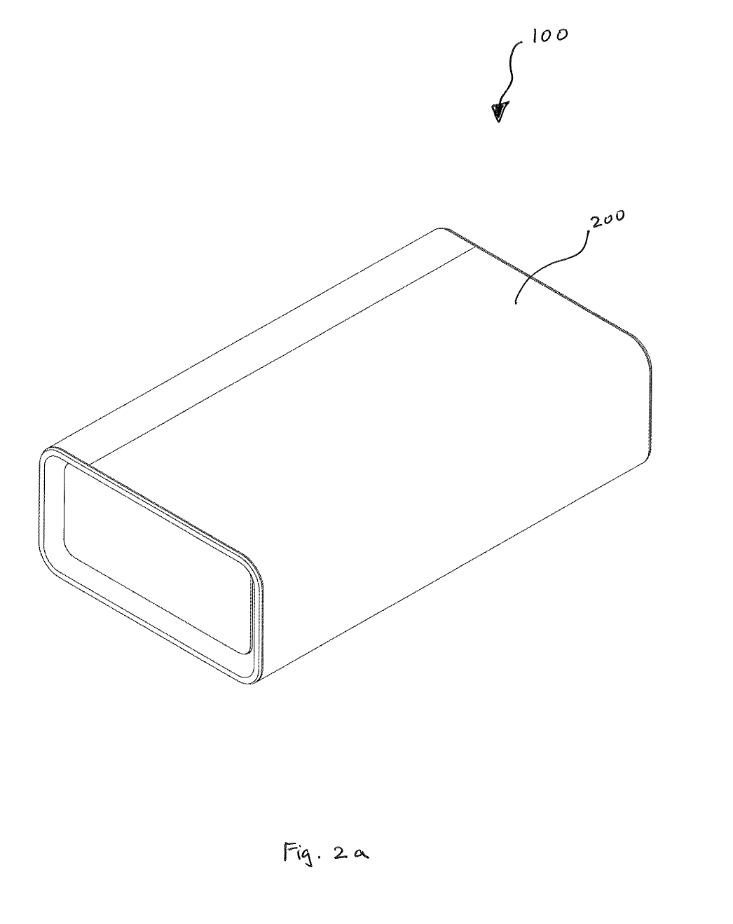

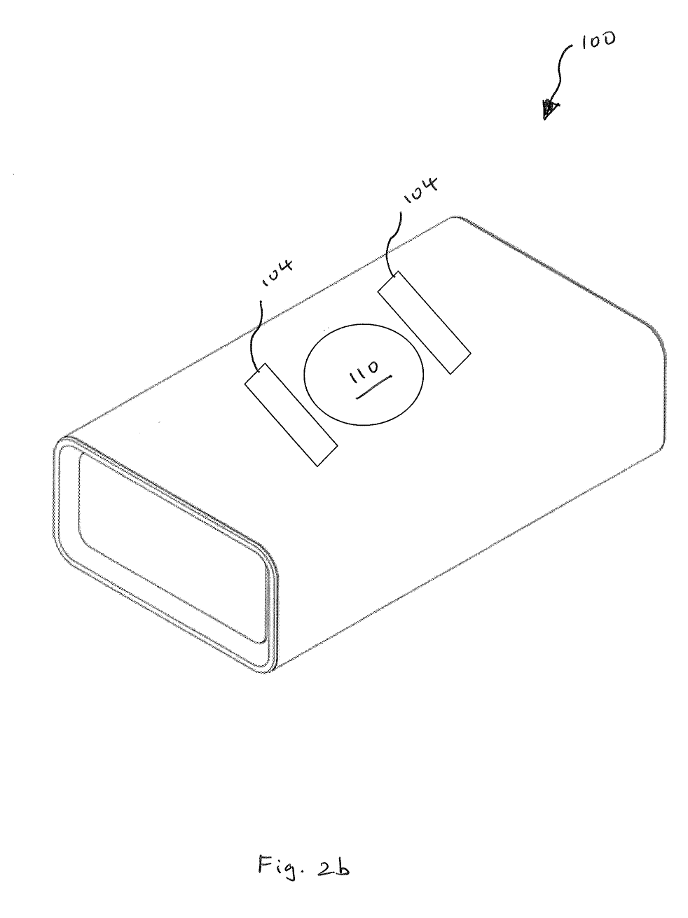

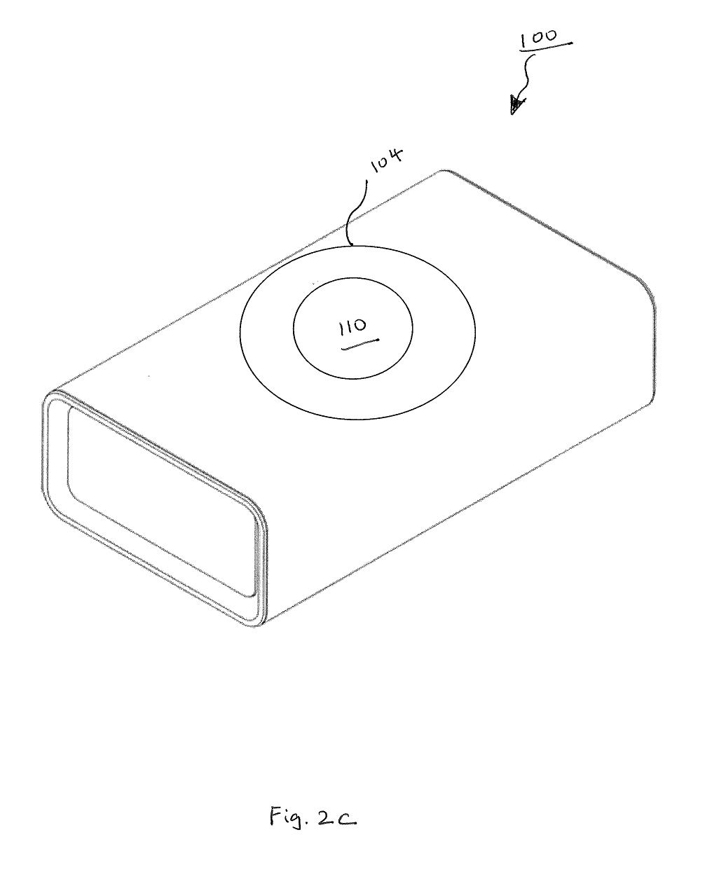

The foregoing will be discussed in further detail hereinafter with reference to FIG. 1 and FIG. 2.

Referring to FIG. 1a and FIG. 1b, there is shown a device 100 in accordance with an embodiment of the disclosure. The device 100 can, for example, be configured to output audio signals. The device 100 can, for example, be a speaker apparatus.

As shown in FIG. 1a and FIG. 1b, the device 100 can include a casing 102, at least one heatsink arrangement 104, a heat conducting channel 106, a heat generating component 108 and, optionally, one or more speaker drivers 110. The one or more speaker drivers 110 can be configured to output audio signals. The device 100 can optionally include a control interface (e.g., a set of buttons) 112 to control the device 100.

The casing 102 can be shaped and dimensioned to carry the heatsink arrangement 104, the heat generating component 108 and, optionally, one or more speaker drivers 110. Additionally, the heat conducting channel 106 can be accommodated within the casing 102. Furthermore, the casing 102 can further be shaped and dimensioned to carry the control interface 112.

FIG. 1a shows an exterior view of the device 100 in accordance with an embodiment of the disclosure. FIG. 1b shows in detail how the heatsink arrangement 104, the heat generating component 108 and the speaker driver 110 can be carried by the casing 102, in accordance with an embodiment of the disclosure.

Referring to FIG. 1a, the casing 102 can, for example, include a first face 102a, a second face 102b and sides 102c. The first face 102a and the second face 102b are opposite each other and are spaced apart such that sides 102c are defined between the first and second faces 102a/102b.

Therefore, the first and second faces 102a/102b can be considered to either be on opposing ends of the sides 102c or be spaced apart by the sides 102c.

The first face 102a, the second face 102b and the sides 102c defined between the first and second faces 102a/102b form an enclosure (labeled as “120” in FIG. 1b). Air can be enclosed within the enclosure. In this regard, the enclosure can be associated with air volume which is defined by air enclosed within the enclosure. The enclosure can generally refer to the internal of the device 100 as will be shown in greater detail in FIG. 1b.

As shown, the heatsink arrangement 104 and, optionally, the speaker driver 110 can, for example, be carried by the first face 102a of the casing 102. Additionally, the control interface 112 can, for example, be carried by the first face 102a of the casing 102. This will be discussed in greater detail with reference to FIG. 1b hereinafter.

Referring to FIG. 1b, the heatsink arrangement 104 can, for example, be carried by the first face 102a of the casing 102. The heat generating component 108 can, for example, be carried by the second face 102b of the casing 102. The heatsink arrangement 104 can be coupled to the heat generating component 108 by the heat conducting channel 106.

In particular, the heatsink arrangement 104 can include a first side 104a and a second side 104b. The first and second sides 104a/104b can be opposing such that they face opposing directions. More particularly, the second side 104b can be opposing the first side 104a such that they, for example, face directly opposing directions. For example, if the first side 104a is facing the north direction, the second side 104b will face the south direction.

When carried by the first face 102a of the casing 102, the first side 104a of the heatsink arrangement 104 can, for example, be facing the outside of the enclosure 120 whereas the second side 104b of the heatsink arrangement 104 can, for example, be facing the inside of the enclosure 120. Appreciably, the first side 104a (i.e., facing outside of the enclosure 120) can be exposed to view whereas the second side 104b (i.e., facing inside of the enclosure 120) can be hidden/obscured from view.

When carried by the second face 102b of the casing 102, the heat generating component 108 is accommodated within the enclosure 120 (i.e., within the device 100).

As mentioned earlier, the heatsink arrangement 104 can be coupled to the heat generating component 108 by the heat conducting channel 106. In this regard, the heat conducting channel 106 can include a first end 106a and a second end 106b.

For example, one of the ends (e.g., the first end 106a) of the heat conducting channel 106 can be connected to the side (e.g., the second side 104b) of the heatsink arrangement 104 which is facing the inside of the enclosure 120 (i.e., internal of the device 100) and another one of the ends (e.g., the second end 106b) of the heat conducting channel 106 can be connected to the heat generating component 108 which is accommodated within the device 100 (i.e., within the casing 102 or, in other words, within the enclosure 120).

In this regard, when heat is generated by the heat generating component 108, the generated heat can be channeled/transferred from the heat generating component 108 to the heatsink arrangement 104 by the heat conducting channel 106 instead of being dissipated directly to the aforementioned air volume (i.e., within the enclosure). Specifically, in this manner, amount of heat (generated by the heat generating component 108) dissipated directly to the air volume can be reduced.

Appreciably, the heatsink arrangement 104 can, in one example, effectively be considered to be partially within the device 100. Specifically, by virtue of one of the sides (e.g., the second side 104b) of the heatsink arrangement 104 facing inside of the enclosure 120, the heatsink arrangement 104 can effectively be considered to be partially within the device 100.

Further appreciably, both the heat conducting channel 106 and the heat generating component 108 are within the casing 102. More specifically, both the heat conducting channel 106 and the heat generating component 108 are within enclosure 120 (i.e., within the device 100).

Therefore, the heat conducting channel 106 couples the heat generating component 108 and the heatsink arrangement 104 so as to channel heat from the heat generating component 108 to the heatsink arrangement 104, effectively reducing amount of heat being dissipated from the heat generating component 108 directly to the air volume (i.e., within the enclosure 120).

Appreciably, the heat conducting channel 106 should be long enough so that it extends across the first face 102a and the second face 102b. Particularly, the heat conducting channel 106 should be long enough so that it extends across the sides 102c between the first and second faces 102a/102b.

Preferably, the heat conducting channel 106 is of a length (i.e., length between the first and second ends 106a/106b which is labeled as “X” in FIG. 1b) which is at least (or longer than) the length (labeled as “Y”) of the sides 102c across/between the first and second faces 102a/102b. This is so that the heat conducting channel is capable of reaching across the distance/length (labeled as “Z”) between the first and second faces 102a/102b within the enclosure 120.

In one exemplary scenario, the device 100 is a speaker apparatus. The casing 102 is in the form of a rectangular cuboid and constructed of a material which has poor thermal conductivity (e.g., insulator type material such as rubber/plastic which does not transfer heat effectively). The heatsink arrangement 104 can be constructed of a material which has good/excellent thermal conductivity (e.g., metal such as copper). The heat conducting channel 106 can be constructed of a material which has good/excellent thermal conductivity (e.g., metal such as copper) similar to the heatsink arrangement 104. The heat generating component 108 can, for example, be a printed circuit board carrying one or more integrated circuit (IC) chips generating heat.

In this regard, the casing 102 can, for example, be a plastic casing. The heatsink arrangement 104 can, for example, correspond to one or more copper plates. The heat conducting channel 106 can, for example, correspond to a wired heat transfer medium in the form of a band of braided copper wires. The heat generating component 108 can, for example, be a printed circuit board (PCB) carrying a power amplifier IC chip which generates heat.

Appreciably, a power amplifier IC chip may generate a significant amount of heat which may cause one or more hotspots either on the IC itself and/or on one or more parts of the PCB. Therefore, one end (e.g., second end 106b) of the band of braided copper wires can be connected (e.g., soldered) to any identifiable hotspot(s) and another end (e.g., first end 106a) of the band of braided copper wires can be connected (e.g., soldered) to the side (e.g., second side 104b) of the copper plate.

Earlier mentioned, since one part/side (e.g., the first side 104a) of the heatsink arrangement 104 faces outside of the enclosure 120, the heatsink arrangement 104 can partially be exposed to view.

Further earlier mentioned, it is preferable that the visible part/side (e.g., the first side 104a) of the heatsink arrangement 104 does not detract the aesthetic value (i.e., outward appearance) of the device 100. To achieve this, it is possible to arrange the heatsink arrangement 104 so that it (i.e., part/side of the heatsink arrangement 104 exposed to view) blends with the general/overall outward appearance of the device 100. This will be discussed in further detail hereinafter with reference to FIG. 2.

Specifically, FIG. 2a to FIG. 2c show various possible arrangements where the device 100 is, for example, a speaker apparatus having a heatsink arrangement 104 and a speaker driver 110. Both the heatsink arrangement 104 and the speaker driver 110 can be carried by the first face 102a of the casing 102.

Referring to FIG. 2a, one possible arrangement is to cover at least the first face 102a of the casing 102 with a speaker grille 200. Specifically, either a hard or soft screen/grille can be mounted directly over both the heatsink arrangement 104 and the speaker driver 110 so as to obscure them from view. Preferably, the speaker grille 200 can be substantially wrapped around the device 100. Further preferably, the speaker grille 200 can be spaced apart from at least the heatsink arrangement 104 so as not to impede effective heat transfer from the heatsink arrangement 104 to ambient by convection (i.e., via air). In this regard, the speaker grille 200 can function/be used as a cover. Additionally, it can be appreciated that the speaker grille 200 (especially a hard grille covering the heatsink arrangement 104 and, at the same time, spaced apart from the heatsink arrangement 104) can further function as a safety measure to prevent human contact with the heatsink arrangement 104 which can become a hot surface.

Referring to FIG. 2b, in another possible arrangement, the heatsink arrangement 104 can include a plurality of discrete parts (labeled as “202” and “204”) arranged around or near the speaker driver 110. Such an arrangement may provide an optical illusion that the heatsink arrangement 104 and the speaker driver 110 are a single unit when they are in actuality separated from each other. In this regard, it is possible to blend appearance of the exposed part/side of the heatsink arrangement 104 with the general/overall outward appearance of the device 100. In one example, the heatsink arrangement 104 can be formed or arranged around the periphery of the speaker driver 110 without actually making contact with the speaker driver 110 so as to reduce heat transfer to the speaker driver 110. As an option, a speaker grille can additionally be provided and used as a cover per earlier discussed in FIG. 2a.

Referring to FIG. 2c, in yet another possible arrangement, the heatsink arrangement 104 can be arranged/formed around the periphery of the speaker driver 110. The heatsink arrangement 104 and the speaker driver 110 can be in contact. In this regard, the heatsink arrangement 104 and the speaker driver 110 can be considered to form a single unit. That is, the heatsink arrangement 104 can be integrated with the speaker driver 110. In another view, the speaker driver 110 can be considered to be an apparatus which can be configured to output audio signals and, at the same time, be capable of acting as a heat dissipating apparatus with its periphery or portions of its periphery acting as a heatsink arrangement 104. Therefore, the speaker driver 110 can be considered to be capable of audio output with its (i.e., the speaker driver 110) periphery acting as a heatsink arrangement 104 for dissipating heat generated by the heat generating component 108 which is within the enclosure 120. Such an arrangement is useful where it is foreseeable (by calculation or design) that amount heat to be dissipated by the heatsink arrangement 104 may not be large enough to adversely impact performance/operation of the speaker driver 110 and an integrated design (i.e., the heatsink arrangement 104 and the speaker driver 110 forming a single unit) advantageously allows appearance of the exposed part/side of the heatsink arrangement 104 to better blend with the general/overall outward appearance of the device 100. As an option, a speaker grille can additionally be provided and used as a cover per earlier discussed in FIG. 2a.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

For example, although possible arrangements (per FIG. 2) are discussed with reference to the speaker driver 110 (e.g., the heatsink arrangement 104 being arranged around /near the speaker driver 110 or the heatsink arrangement 104 being arranged/formed around the periphery of the speaker driver 110), it is appreciable that the discussion can analogously apply to other components such as the control interface 112 (e.g., the heatsink arrangement 104 being arranged around /near the control interface 112).

1. A device having a heatsink arrangement for dissipating heat within the device, the device comprising:
at least one heat generating component;
a casing to carry the heatsink arrangement and the heat generating component, the casing comprising:
a first face carrying the heatsink arrangement; and
a second face carrying the heat generating component, the first and second faces being spaced apart such that sides are defined between the first and second faces,
wherein the first face, the second face and the sides defined therebetween form an enclosure, the enclosure being associable air volume which is defined by air enclosed within the enclosure, and
a heat conducting channel coupling the heat generating component and the heatsink arrangement so as to channel heat from the heat generating component to the heatsink arrangement, thereby reducing amount of heat being dissipated from the heat generating component directly to the air volume,
wherein the heat generating component and the heat conducting channel are within the enclosure.

2. The device as in claim 1,
wherein the heatsink arrangement comprises a first side and a second side opposing the first side, and
wherein the heatsink arrangement is carried by the first face in a manner such that the first side of the heatsink arrangement faces outside of the enclosure and the second side of the heatsink arrangement faces inside of the enclosure.

3. A device configurable to output audio signals and having a heatsink arrangement for dissipating heat within the device, the device comprising:
at least one heat generating component;
at least one speaker driver configurable to output audio signals;
a casing to carry the heatsink arrangement, the heat generating component and the speaker driver, the casing comprising:
a first face carrying the heatsink arrangement and the speaker driver, the heatsink arrangement being arranged around the speaker driver; and
a second face carrying the heat generating component, the first and second faces being spaced apart such that sides are defined between the first and second faces,
wherein the first face, the second face and the sides defined therebetween form an enclosure, the enclosure being associable air volume which is defined by air enclosed within the enclosure, and
a heat conducting channel coupling the heat generating component and the heatsink arrangement so as to channel heat from the heat generating component to the heatsink arrangement, thereby reducing amount of heat being dissipated from the heat generating component directly to the air volume,
wherein the heat generating component and the heat conducting channel are within the enclosure.

4. The device as in claim 3, wherein the heatsink arrangement is formed around the periphery of the speaker driver.

5. The device as in claim 4, wherein the heatsink arrangement and the speaker driver form a single unit.

6. The device as in claim 4, wherein the heat conducting channel is a wired heat transfer medium in the form of braided copper wires.
